(19) United States
(12) Patent Application Publication
(10) Pub. No.: US 2010/0058073 A1
(43) Pub. Date: Mar. 4, 2010

(54) STORAGE SYSTEM, CONTROLLER, AND DATA PROTECTION METHOD THEREOF

(75) Inventors: Hon-Wai Ng, Miaoli (TW); Ching-Wen Chang, Hsinchu City (TW); Jiunn-Yeong Yang, Keelung City (TW); Chee-Kong Awyong, Miaoli (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/345,444

(22) Filed: Dec. 29, 2008

(30) Foreign Application Priority Data
Aug. 29, 2008 (TW) 97133279

(51) Int. Cl. G06F 12/14; H04L 9/32

(52) U.S. Cl. 713/193

(57) ABSTRACT

A storage system including a storage unit, a connector, and a controller is provided. A personal identification number (PIN) message digest and a cipher text are stored in the storage unit. When the storage system is connected to a host system through the connector, the controller requests a password from the host system and generates a message digest through a one-way hash function according to the password. After that, the controller determinates whether the message digest matches the PIN message digest. If the message digest matches the PIN message digest, the controller decrypts the cipher text in the storage unit through a first encryption/decryption function according to the password to obtain an encryption/decryption key. Eventually, the controller encrypts and decrypts user data through a second encryption/decryption function according to the encryption/decryption key. Thereby, the user data stored in the storage system can be effectively protected.

### CROSS-REFERENCE TO RELATED APPLICATION

This application claims the priority benefit of Taiwan application serial no. 97133279, filed Aug. 29, 2008. The entirety of the above-mentioned patent application is hereby incorporated by reference herein and made a part of this specification.

### BACKGROUND

1. Technology Field

The present invention generally relates to a storage system, and more particularly, to a storage system with a data protection function and a controller and a data protection method thereof.

2. Description of Related Art

A flash drive is a data storage device which usually uses a flash memory as its storage medium. A flash memory is an electrically erasable programmable read-only memory (EEPROM) which provides high re-record-ability and power-free data storage. Besides, a flash memory is also a non-volatile memory and accordingly it offers small volume, fast access speed, and low power consumption. Moreover, a flash memory has very fast operation speed because data is erased from it in a block by block manner. Due to its small volume and convenience to be carried around, flash drive has been broadly adopted for storing personal data. However, if a flash drive is lost, the data stored therein may be misappropriated as well.

To resolve foregoing problem, a specific area (for example, a hidden area which is inaccessible to users) is usually specified in the flash memory of a flash drive and an authentication program and a password pre-established by a user are stored in the specific area. When the user plugs the flash drive into a host system, the flash drive requests the host system to execute the authentication program and request the user to input a password. The authentication program then compares the password input by the user with the password stored in the flash drive. If the two do not match each other or the authentication program is not executed, the host system can only detect the flash drive but the user cannot access the flash drive. Through such a locking mechanism, data stored in the flash drive can be protected.

However, in the locking mechanism described above, even though the password is stored in the hidden area which is inaccessible to general users, the manufacturer (or designer) of the flash drive knows clearly about the position of the hidden area. When the manufacturer obtains a user's flash drive, the manufacturer can easily obtain the password stored in the hidden area and release the locking mechanism. Or, the manufacturer may even skip the locking mechanism and directly read the user data stored in the flash drive. Thus, a better protection mechanism for protecting the data stored in a flash drive from being stolen by unauthorized users (in particular, the manufacturer or designer of the flash drive) is desired.

### SUMMARY

Accordingly, the present invention is directed to a storage system which can effectively prevent data stored therein from being accessed by unauthorized users.

The present invention is directed to a controller suitable for a flash memory storage system, wherein the controller can effectively prevent data stored in the flash memory storage system from being accessed by unauthorized users.

The present invention is further directed to a data protection method suitable for a storage system, wherein the data protection method can effectively prevent data stored in the storage system from being accessed by unauthorized users.

The present invention provides a storage system including a storage unit, a connector, and a controller. The storage unit stores a personal identification number (PIN) message digest and a cipher text, wherein the PIN message digest is initially generated according to a PIN through a one-way hash function, and the cipher text is initially generated by encrypting an encryption/decryption key according to the PIN through a first encryption/decryption function. The connector is used for connecting to a host system. The controller is electrically connected to the storage unit and the connector, wherein the controller requests a password from the host system and generates a message digest corresponding to the password through the one-way hash function according to the password. In addition, the controller determines whether the message digest corresponding to the password matches the PIN message digest in the storage unit. When the message digest corresponding to the password matches the PIN message digest in the storage unit, the controller decrypts the cipher text through the first encryption/decryption function according to the password to obtain the encryption/decryption key. Moreover, the controller encrypts and decrypts at least part of user data through a second encryption/decryption function according to the encryption/decryption key.

The present invention provides a controller suitable for controlling a storage system having a storage unit. The controller includes a microprocessor unit, a host interface module electrically connected to the microprocessor unit, a one-way encoding unit, a first encryption/decryption unit, and a second encryption/decryption unit. When the storage system is connected to a host system, the microprocessor unit requests a password from the host system. The one-way encoding unit generates a message digest corresponding to the password through a one-way hash function according to the password. The first encryption/decryption unit decrypts a cipher text stored in the storage unit according to the password through a first encryption/decryption function to obtain an encryption/decryption key when the microprocessor unit determines that the message digest corresponding to the password matches the PIN message digest stored in the storage unit. The second encryption/decryption unit encrypts and decrypts at least part of user data according to the encryption/decryption key through a second encryption/decryption function, wherein the PIN message digest is initially generated through the one-way hash function according to a PIN, and the cipher text is initially generated by encrypting the encryption/decryption key through the first encryption/decryption function according to the PIN.

The present invention provides a data protection method for protecting user data stored in a storage unit of a storage system. The data protection method includes storing a PIN message digest and a cipher text in the storage unit. The data protection method also includes generating a message digest corresponding to a password received from a host system through a one-way hash function according to the password and determining whether the message digest corresponding to the password matches the PIN message digest stored in the storage unit. The data protection method further includes decrypting the cipher text in the storage unit through a first encryption/decryption function according to the password to obtain an encryption/decryption key and encrypting and decrypting at least part of the user data through a second encryption/decryption function according to the encryption/decryption key when the message digest corresponding to the password matches the PIN message digest in the storage unit. The PIN message digest is initially generated through the one-way hash function according to a PIN, and the cipher text is initially generated by encrypting the encryption/decryption key through the first encryption/decryption function according to the PIN.

In the present invention, a PIN message digest which can only be calculated through a one-way hash function is stored in a storage system in order to prevent unauthorized users from being accessing a PIN, and user data is encrypted by using an encryption/decryption key in order to prevent unauthorized users from releasing the locking mechanism and directly accessing the user data stored in the storage system.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram of a flash memory storage system according to an exemplary embodiment of the present invention.

FIG. 2 is a flowchart illustrating the steps for establishing a personal identification number (PIN) in a data protection method according to an exemplary embodiment of the present invention.

FIG. 3 is a flowchart illustrating the steps of user authentication in a data protection method according to an exemplary embodiment of the present invention.

FIG. 4 is a flowchart illustrating the steps of updating a PIN in a data protection method according to an exemplary embodiment of the present invention.

FIG. 5 illustrates a window provided to a user for starting the processes illustrated in FIG. 2, FIG. 3, and FIG. 4 according to an exemplary embodiment of the present invention.

### DESCRIPTION OF THE EXEMPLARY EMBODIMENTS

Reference will now be made in detail to the present preferred exemplary embodiments of the invention, examples of which are illustrated in the accompanying drawings. Wherever possible, the same reference numbers are used in the drawings and the description to refer to the same or like parts.

In order to prevent a manufacturer or an engineer of a storage system from obtaining the personal identification number (PIN) established by a user, in the present invention, the PIN established by the user is first encrypted through a one-way hash function before it is stored into the storage system.

Besides, in order to prevent a manufacturer or an engineer of a storage system from directly accessing user data stored in the storage system, in the present invention, the user data is first encrypted by using an encryption/decryption key before it is stored into the storage system. In particular, the encryption/decryption key is encrypted by using the PIN established by the user before it is stored in the storage system.

Accordingly, the user data stored in the storage system can be effectively protected through the dual-layer protection mechanism described above. Below, exemplary embodiments of the present invention will be described with reference to accompanying drawings.

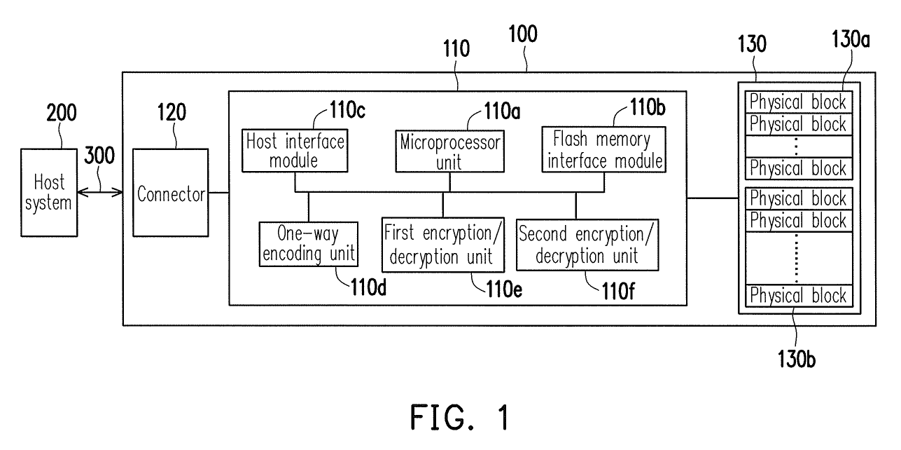

FIG. 1 is a schematic block diagram of a flash memory storage system according to an exemplary embodiment of the present invention. Referring to FIG. 1, the flash memory storage system 100 includes a controller (also referred to as a controller system) 110, a connector 120, and a flash memory chip 130.

The flash memory storage system 100 usually works together with a host system 200 to allow the host system 200 to write data into or read data from the flash memory storage system 100. In particular, the flash memory storage system 100 has a data protection function provided by the present exemplary embodiment. Thereby, a user cannot access the flash memory storage system 100 if the user does not pass the authentication. The data protection method in the present exemplary embodiment will be described in detail below. In the present exemplary embodiment, the flash memory storage system 100 is a flash drive. However, in another exemplary embodiment of the present invention, the flash memory storage system 100 may also be a flash memory card or a solid state drive (SSD).

The controller 110 executes a plurality of machine instructions implemented as hardware or firmware to store, read, or erase data along with the connector 120, a cache 140, and the flash memory chip 130. The controller 110 includes a microprocessor unit 110a, a flash memory interface module 110b, a host interface module 110c, a one-way encoding unit 110d, a first encryption/decryption unit 110e, and a second encryption/decryption unit 110f.

The microprocessor unit 110a cooperates with the flash memory interface module 110b, the host interface module 110c, the one-way encoding unit 110d, the first encryption/decryption unit 110f, and the second encryption/decryption unit 110g to carry out various operations of the flash memory storage system 100. Particularly, in the present exemplary embodiment, when the flash memory storage system 100 is connected to the host system 200, the microprocessor unit 110a requests a password from the host system 200 to determine whether the host system 200 can access the flash memory storage system 100. In other words, if the user of the host system 200 does not input any password or inputs a wrong password, the host system 200 is not allowed to perform any access operation to the flash memory storage system 100.

The flash memory interface module 110b is electrically connected to the microprocessor unit 110a for accessing the flash memory chip 130. In other words, data to be written into the flash memory chip 130 is converted by the flash memory interface module 110b into a format acceptable to the flash memory chip 130.

The host interface module 110c is electrically connected to the microprocessor unit 110a for receiving and identifying a command received from the host system 200. Namely, the command and data received from the host system 200 are transmitted to the microprocessor unit 110a through the host interface module 110c. In the present exemplary embodiment, the host interface module 110c is a USB interface. However, the present invention is not limited thereto, the host interface module 110c may also be a PCI Express interface, an IEEE 1394 interface, a SD interface, a MS interface, a MMC interface, a SATA interface, a PATA interface, a CF interface, an IDE interface, or other suitable data transmission interfaces. In particular, the host interface module 110c is corresponding to the connector 120. Namely, the host interface module 110c has to be compatible to the connector 120.

The one-way encoding unit 110d is electrically connected to the microprocessor unit 110a. In the present exemplary embodiment, the one-way encoding unit 110d generates a message digest according to the password input into the host system 200 by the user. To be specific, the one-way encoding unit 110d has a one-way hash function, and the password input into the host system 200 by the user is input into the one-way hash function to calculate the message digest corresponding to the password. After that, the microprocessor unit 110a compares the message digest with a PIN message digest stored in the flash memory storage system 100. The host system 200 is allowed to access the flash memory storage system 100 if the message digest matches the PIN message digest stored in the flash memory storage system 100.

It should be mentioned that the PIN message digest stored in the flash memory storage system 100 is generated through the one-way hash function according to a PIN set by the owner of the flash memory storage system 100. For example, when the flash memory storage system 100 is manufactured, a PIN message digest is pre-recorded in the flash memory storage system 100, and the PIN corresponding to the PIN message digest is handed over to the user. Subsequently, the user can successfully pass the authentication of the flash memory storage system 100 by using the PIN provided by the manufacturer and resets a new PIN by using a PIN updating function provided by the microprocessor unit 110a. In particular, when the user sets a new PIN, the one-way encoding unit 110d calculates a new PIN message digest through the one-way hash function according to the new PIN, and the microprocessor unit 110a stores the new PIN message digest into the flash memory storage system 100 to replace (or update) the original PIN message digest. Thereafter, the microprocessor unit 110a authenticates the password input by the user by using the latest PIN message digest.

In the present exemplary embodiment, the one-way hash function in the one-way encoding unit 110d is implemented as SHA-256. However, the present invention is not limited thereto, and in another exemplary embodiment of the present invention, the one-way hash function in the one-way encoding unit 110d may also be implemented as MD5, RIPEMD-160 SHA1, SHA-386, SHA-512, or other suitable functions.

The first encryption/decryption unit 110e is electrically connected to the microprocessor unit 110a. The first encryption/decryption unit 110e decrypts a cipher text according to the password input by the user to obtain an encryption/decryption key of the flash memory storage system 100. To be specific, when the microprocessor unit 110a determines that the message digest corresponding to the password matches the PIN message digest stored in the flash memory storage system 100, the password input by the user is transmitted to the first encryption/decryption unit 110e and the first encryption/decryption unit 110e decrypts the cipher text stored in the flash memory storage system 100 through the first encryption/decryption function according to the password, so as to obtain the encryption/decryption key of the flash memory storage system 100.

In the present exemplary embodiment, the encryption/decryption key is used for encrypting/decrypting user data stored in the flash memory storage system 100. Namely, the user data to be written by the host system 200 into the flash memory storage system 100 is encrypted by using the encryption/decryption key before it is written into the flash memory chip 130, and the data read from the flash memory chip 130 has to be decrypted by using the encryption/decryption key before it can be read by the host system 200.

The encryption/decryption key is generated in a random manner through a random number generator (not shown) when the flash memory storage system 100 is manufactured. In particular, the first encryption/decryption unit 110e encrypts the encryption/decryption key through the first encryption/decryption function according to the PIN and stores the cipher text obtained by encrypting the encryption/decryption key into the flash memory storage system 100. Thus, when the password input by the user passes the authentication, the password can be used for decrypting the cipher text stored in the flash memory storage system 100, so as to obtain the encryption/decryption key.

Similarly, the cipher text stored in the flash memory storage system 100 is generated by encrypting the encryption/decryption key through the first encryption/decryption function according to the PIN preset by the owner of the flash memory storage system 100. For example, when the flash memory storage system 100 is just manufactured, the manufacturer encrypts the encryption/decryption key through the first encryption/decryption function by using the preset PIN to generate the cipher text and stores the cipher text into the flash memory storage system 100. Subsequently, when the user successfully passes the authentication of the flash memory storage system 100 by using the PIN and resets a new PIN by using the PIN updating function provided by the microprocessor unit 110a, the first encryption/decryption unit 110e decrypts the cipher text in the flash memory storage system 100 through the first encryption/decryption function according to the old PIN to obtain the encryption/decryption key, and encrypts the encryption/decryption key by using the new PIN through the first encryption/decryption function to obtain the new cipher text. Next, the microprocessor unit 110a stores the new cipher text into the flash memory storage system 100 to replace (or update) the original cipher text. Thereafter, the first encryption/decryption unit 110e calculates the encryption/decryption key of the flash memory storage system 100 by using the latest cipher text.

In the present exemplary embodiment, the first encryption/decryption function in the first encryption/decryption unit 110e is implemented as an advance encryption standard (AES)128. However, the present invention is not limited thereto, and in another exemplary embodiment of the present invention, the first encryption/decryption function in the first encryption/decryption unit 110e may also be implemented as an AES256 or a data encryption standard (DES).

The second encryption/decryption unit 110f is electrically connected to the microprocessor unit 110a. The second encryption/decryption unit 110f encrypts the user data to be written into the flash memory chip 130 and decrypts the user data reads from the flash memory chip 130 according to the encryption/decryption key. It should be mentioned that the encryption/decryption key generated by the random number generator has to be compatible to the second encryption/decryption function in the second encryption/decryption unit 110f.

In the present exemplary embodiment, the second encryption/decryption function in the second encryption/decryption unit 110f is implemented as AES256. However, the present invention is not limited thereto, and in another exemplary embodiment of the present invention, the second encryption/decryption function in the second encryption/decryption unit 110f may also be implemented through AES128 or DES.

It should be mentioned that in the present exemplary embodiment, the one-way encoding unit 110d, the first encryption/decryption unit 110e, and the second encryption/decryption unit 110f are implemented in the controller 110 as hardware. However, in another exemplary embodiment of the present invention, the one-way encoding unit 110d, the first encryption/decryption unit 110e, and the second encryption/decryption unit 110f may also be implemented in the controller 110 as a firmware. For example, the one-way encoding unit 110d, the first encryption/decryption unit 110e, and the second encryption/decryption unit 110f in may also be implemented in the controller 110 by writing related machine instructions in a programming language and storing the machine instructions into a program memory (for example, a read-only memory, ROM). When the flash memory storage system 100 is in operation, the machine instructions for implementing the one-way encoding unit 110d, the first encryption/decryption unit 110e, and the second encryption/decryption unit 110f are loaded into a buffer memory (not shown) of the controller 110 and executed by the microprocessor unit 110a or directly executed by the microprocessor unit 110a to accomplish foregoing data protection steps.

In another exemplary embodiment of the present invention, the machine instructions of the one-way encoding unit 110d, the first encryption/decryption unit 110e, and the second encryption/decryption unit 110f may also be stored in a specific area (for example, a system area 130a) of the flash memory chip 130 as a firmware. Similarly, when the flash memory storage system 100 is in operation, the machine instructions for implementing the one-way encoding unit 110d, the first encryption/decryption unit 110e, and the second encryption/decryption unit 110f are loaded into the buffer memory (not shown) of the controller 110 and executed by the microprocessor unit 110a.

Even though not shown in the present exemplary embodiment, the controller 110 may further include other functional modules for controlling the flash memory chip 130, such as the buffer memory (for example, a static random access memory, SRAM), an error correction module, and a power management module, etc.

The connector 120 is used for connecting to the host system 200 through a bus 300. In the present exemplary embodiment, the connector 120 is a USB connector. However, the present invention is not limited thereto, and the connector 120 may also be a PCI Express connector, an IEEE 1394 connector, a SD connector, a MS connector, a MMC connector, a SATA connector, a CF connector, an IDE connector, a PATA connector, or other suitable connectors.

The flash memory chip 130 is electrically connected to the controller 110 for storing data. In the present exemplary embodiment, the flash memory chip 130 is a multi level cell (MLC) NAND flash memory chip. However, the present invention is not limited thereto, and in another exemplary embodiment of the present invention, the flash memory chip 130 may also be a single level cell (SLC) NAND flash memory chip.

In the present exemplary embodiment, the flash memory chip 130 includes a plurality of physical blocks, and these physical blocks are grouped into the system area 130a and a storage area 130b.

Physical blocks in the system area 130a are used for storing system data of the flash memory chip, such as the number of pages in each physical block and a logical-physical mapping table for recording the mapping relationship between logical addresses and physical addresses. Particularly, in the present exemplary embodiment, the system area 130a is used for storing the PIN message digest and the cipher text.

The storage area 130b is used for storing user data written by the host system 200. To be specific, the user data to be written into the flash memory storage system 100 by the host system 200 is encrypted by using the encryption/decryption key and then written into the storage area 130b. Namely, if the user of the host system 200 does not input a password or inputs a wrong password, the flash memory storage system 100 does not allow the host system 200 to access the storage area 130b.

In another exemplary embodiment of the present invention, the controller 110 also groups the physical blocks in the storage area 130b into a security area and a non-security area, wherein if the user of the host system 200 does not input a password or input a wrong password, the flash memory storage system 100 does not allow the host system 200 to access the security area thereof. Namely, when the user does not pass the authentication, the controller 110 cannot detect the security area and accordingly the host system 200 can only access the non-security area.

It should be mentioned that in the present exemplary embodiment, the physical blocks in the flash memory chip 130 are grouped into a system area 130a for storing the PIN message digest and the cipher text. However, in another exemplary embodiment of the present invention, a non-volatile storage unit may be further disposed in the flash memory storage system 100 for storing the PIN message digest and the cipher text. Because the flash memory storage system 100 cannot operate properly without the PIN message digest and the cipher text, it has to be ensured that the user will not accidentally delete the PIN message digest or the cipher text regardless of whether the PIN message digest and the cipher text is stored in the system area 130a or the non-volatile storage unit. For example, the system area 130a or the non-volatile storage unit may be designed as a hidden area which can only be accessed by the controller 110, and accordingly the host system 200 (or the user) cannot access the data in the hidden area.

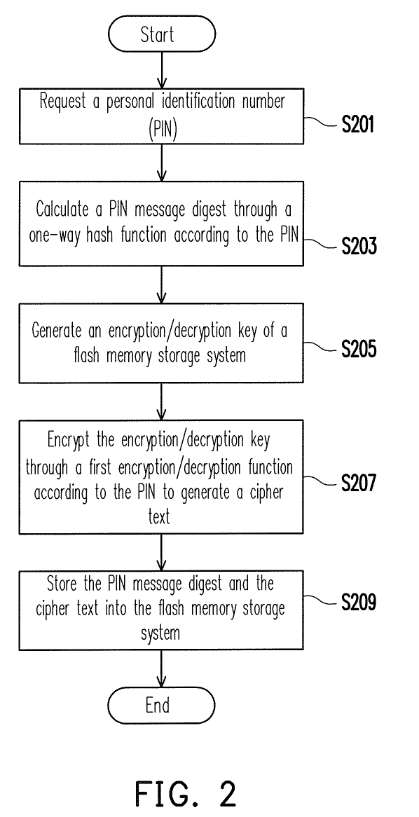

FIG. 2 illustrates the steps for establishing a PIN in a data protection method according to an exemplary embodiment of the present invention.

Referring to FIG. 2, when the flash memory storage system 100 is about to set the PIN initially, in step S201, a PIN is requested. Then, in step S203, a PIN message digest is calculated according to the PIN through a one-way hash function. Next, in step S205, an encryption/decryption key of the flash memory storage system 100 is generated through a random number generator (not shown), and in step S207, the encryption/decryption key is encrypted through the first encryption/decryption function according to the PIN to generate a cipher text. Finally, in step S209, the PIN message digest and the cipher text are stored in the flash memory storage system 100. Through foregoing steps S201˜S209, the PIN is established in the flash memory storage system 100. Subsequently, when the user is about to use the flash memory storage system 100, the controller 110 in the flash memory storage system 100 determines whether the user can use the flash memory storage system 100 through following authentication process.

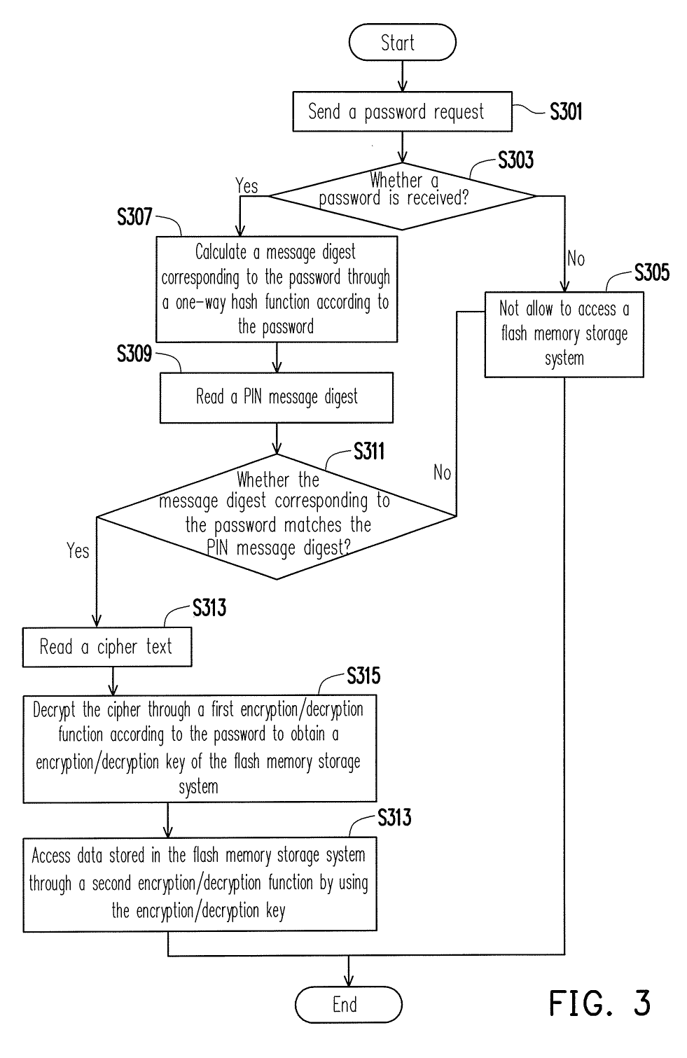

FIG. 3 illustrates the steps of user authentication in a data protection method according to an exemplary embodiment of the present invention.

Referring to FIG. 3, when the user connects the flash memory storage system 100 to the host system 200, in step S301, the flash memory storage system 100 sends a password request signal to the host system 200. For example, the controller 110 of the flash memory storage system 100 requests the host system 200 to execute a password input window program pre-installed in the flash memory storage system 100 or the host system 200 so that the user can input a password.

In step S303, whether a password is received is determined. If it is determined in step S303 that no password is received from the host system 200, in step S305, the host system 200 is not allowed to access the flash memory storage system 100 and the process illustrated in FIG. 3 is ended.

If it is determined in step S303 that the controller 110 receives the password from the host system 200, in step S307, a message digest corresponding to the password is calculated through the one-way hash function according to the password.

Next, in step S309, the PIN message digest stored in the flash memory storage system 100 is read, and in step S311, whether the message digest corresponding to the password matches the PIN message digest stored in the flash memory storage system 100 is determined. If it is determined in step S311 that the message digest corresponding to the password does not match the PIN message digest in the flash memory storage system 100, step S305 is performed to represent the authentication fails and the process illustrated in FIG. 3 is ended.

If it is determined in step S311 that the message digest corresponding to the password matches the PIN message digest in the flash memory storage system 100 (which means the user of the host system 200 is the legal owner of the flash memory storage system 100), in step S313, the cipher text stored in the flash memory storage system 100 is read, and in step S315, the cipher text read from the flash memory storage system 100 is decrypted through the first encryption/decryption function according to the password to obtain the encryption/decryption key of the flash memory storage system 100.

Next, in step S317, data in the storage area 130b is properly accessed by using the encryption/decryption key and the second encryption/decryption function. It should be mentioned herein that the data access in step S317 can be performed until the flash memory storage system 100 is shut down. Additionally, in another exemplary embodiment of the present invention, a login/logout window program may be provided to the user so that the user can decide whether to use the flash memory storage system 100 or not.

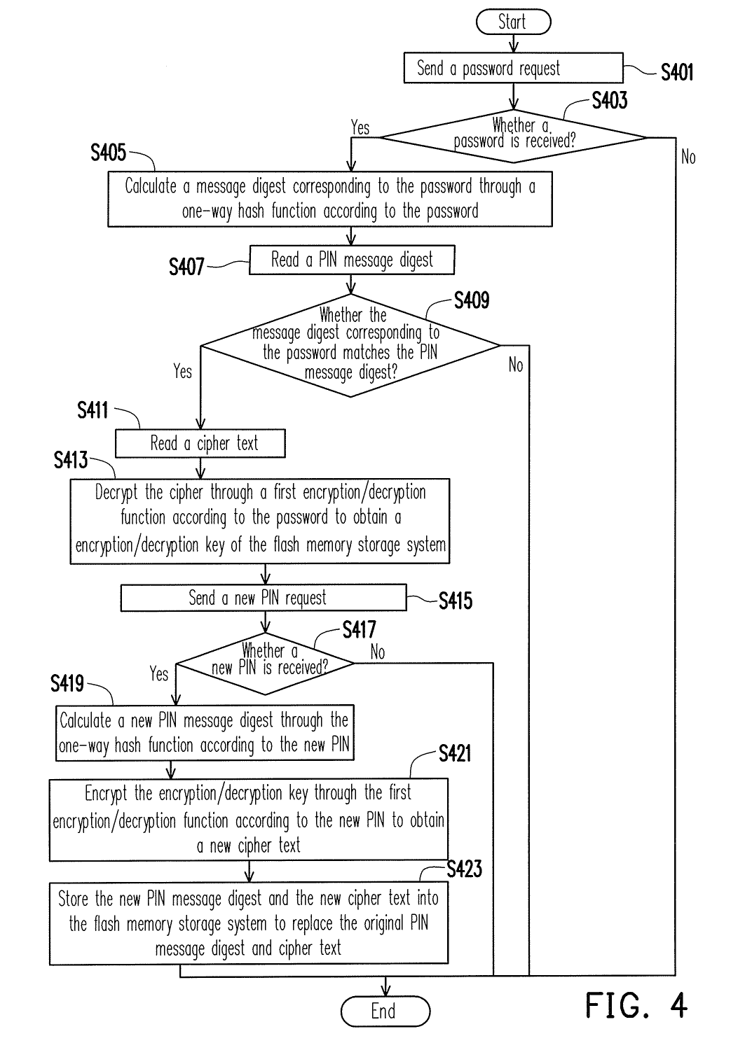

Moreover, in another exemplary embodiment of the present invention, the controller 110 further provides a PIN updating function to allow the user to update the PIN. FIG. 4 illustrates the steps for updating a PIN in a data protection method according to an exemplary embodiment of the present invention.

Referring to FIG. 4, when the flash memory storage system 100 is connected to the host system 200 and the user of the host system 200 requests to update the PIN of the flash memory storage system 100, in step S401, the flash memory storage system 100 sends a password request signal to the host system 200.

In step S403, whether a password is received is determined. If it is determined in step S403 that no password is received from the host system 200, the process illustrated in FIG. 4 is ended without updating the PIN.

If it is determined in step S403 that a password is received from the host system 200, in step S405, a message digest corresponding to the password is calculated through the one-way hash function according to the password.

Next, in step S407, the controller 110 reads the PIN message digest from the flash memory storage system 100, and in step S409, the controller 110 determines whether the message digest corresponding to the password matches the PIN message digest read from the flash memory storage system 100. If it is determined in step S409 that the message digest corresponding to the password does not match the PIN message digest read from the flash memory storage system 100, the authentication fails and the process illustrated in FIG. 4 is ended without updating the PIN.

If it is determined in step S409 that the message digest corresponding to the password matches the PIN message digest stored in the flash memory storage system 100 (which means the user of the host system 200 passes the authentication), in step S411, the cipher text stored in the flash memory storage system 100 is read, and in step S413, the cipher text read from the system area 130a is decrypted through the first encryption/decryption function according to the password to obtain the encryption/decryption key of the flash memory storage system 100.

Thereafter, in step S415, the user of the host system 200 is requested to input a new PIN, and in step S417, whether a new PIN is received from the host system 200 is determined. If it is determined in step S417 that the host system 200 does not send any new PIN, the process illustrated in FIG. 4 is ended without updating the PIN.

If the new PIN is received in step S417, then in step S419, a new PIN message digest corresponding to the new PIN is calculated through the one-way hash function according to the new PIN, and in step S421, the encryption/decryption key obtained in step S415 is encrypted through the first encryption/decryption function according to the new PIN to obtain a new cipher text. Finally, in step S423, the new PIN message digest and the new cipher text are stored into the flash memory storage system 100 to replace the original PIN message digest and cipher text. By now the PIN is successfully updated.

It should be mentioned that in order to prevent unauthorized users from updating the PIN, whether the user of the host system 200 is a legal owner of the flash memory storage system 100 is first determined in the process illustrated in FIG. 4. However, the controller 110 needs only to execute steps S417˜S423 to update the PIN when the flash memory storage system 100 is already in the state illustrated in step S317 of FIG. 3 and the user requests to update the PIN.

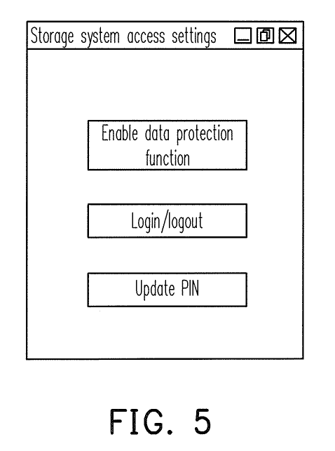

It should be mentioned that in the present exemplary embodiment, the data protection function is disposed in the flash memory storage system 100 when the flash memory storage system 100 is manufactured. Thus, the steps in FIG. 2 for establishing the PIN include presetting a PIN when the flash memory storage system 100 is manufactured and resetting the PIN by the user through the steps illustrated in FIG. 4. However, in another exemplary embodiment of the present invention, the data protection function of the flash memory storage system 100 may also be designed to be in an off state. When the user is about to start the data protection function, the PIN can be set by executing a predetermined program pre-installed in the flash memory storage system 100. Namely, when the flash memory storage system 100 is connected to the host system 200, the controller 110 allows the host system 200 to execute a window program (as shown in FIG. 5) to allow the user of the host system 200 to select a program to be executed, wherein the interactive window programs can be accomplished according to the conventional technique therefore will not be described herein.

Additionally, the data protection steps provided present invention is not limited to the order illustrated in FIG. 2, FIG. 3, and FIG. 4; instead, they may also be implemented in other orders.

It should be understood that the present exemplary embodiment is described with a flash memory storage system as an example; however, the present invention may also be applied to other types of storage systems.

In overview, according to the present invention, a PIN message digest which can only be generated through a one-way hash function is served as the information for authenticating a user such that unauthorized users are prevented from accessing a PIN stored in the flash memory storage system or deduce the PIN from the PIN message digest. Moreover, the encryption/decryption key for encrypting/decrypting user data is encrypted before it is stored in the flash memory storage system. Thereby, unauthorized users are prevented from accessing the encryption/decryption key from the flash memory storage system. Furthermore, when a user updates the PIN, only the cipher text stored in the flash memory storage system is updated while the encryption/decryption key is not changed. Thereby, data previously encrypted and stored in the flash memory storage system needs not to be encrypted/decrypted again so that the working efficiency of the flash memory storage system is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A storage system, comprising:
a storage unit, for storing a personal identification number (PIN) message digest and a cipher text, wherein the PIN message digest is initially generated through a one-way hash function according to a PIN, and the cipher text is initially generated by encrypting an encryption/decryption key through a first encryption/decryption function according to the PIN;
a connector, for connecting to a host system; and
a controller, electrically connected to the storage unit and the connector,
wherein the controller requests a password from the host system and generates a message digest through the one-way hash function according to the password,
wherein the controller determines whether the message digest matches the PIN message digest, and the controller decrypts the cipher text through the first encryption/decryption function according to the password to obtain the encryption/decryption key when the message digest matches the PIN message digest, and
wherein the controller encrypts and decrypts at least a part of user data through a second encryption/decryption function according to the encryption/decryption key.

2. The storage system according to claim 1, further comprising a random number generator for initially generating the encryption/decryption key.

3. The storage system according to claim 1, wherein when the controller determines that the message digest matches the PIN message digest, the controller further generates a new PIN message digest according to a new PIN, encrypts the encryption/decryption key according to the new PIN to generate a new cipher text, and stores the new PIN message digest and the new cipher text into the storage unit to replace the PIN message digest and the cipher text.

4. The storage system according to claim 1, wherein the storage unit is a flash memory chip.

5. The storage system according to claim 4, wherein the flash memory chip comprises a system area and a storage area, wherein the PIN message digest and the cipher text are stored in the system area and the user data is stored in the storage area.

6. The storage system according to claim 5, wherein the storage area comprises a security area and a non-security area, and the encrypted user data is stored in the security area, wherein the controller cannot detect the security area when the message digest does not match the PIN message digest.

7. A controller, suitable for controlling a storage system having a storage unit, the controller comprising:
a microprocessor unit, wherein when the storage system is connected to a host system, the microprocessor unit requests a password from the host system;
a host interface module, electrically connected to the microprocessor unit;
a one-way encoding unit, electrically connected to the microprocessor unit, for generating a message digest through a one-way hash function according to the password;
a first encryption/decryption unit, electrically connected to the microprocessor unit, wherein when the microprocessor unit determines that the message digest matches a PIN message digest, the first encryption/decryption unit decrypts a cipher text through a first encryption/decryption function according to the password to obtain a encryption/decryption key; and
a second encryption/decryption unit, electrically connected to the microprocessor unit, for encrypting and decrypting at least a part of user data through a second encryption/decryption function according to the encryption/decryption key,
wherein the PIN message digest and the cipher text are stored in the storage unit, the PIN message digest is initially generated through the one-way hash function according to a PIN, and the cipher text is initially generated by encrypting the encryption/decryption key through the first encryption/decryption function according to the PIN.

8. The controller according to claim 7, further comprising a random number generator for initially generating the encryption/decryption key.

9. The controller according to claim 7, wherein when the microprocessor unit determines that the message digest matches the PIN message digest, the one-way encoding unit further generates a new PIN message digest through the one-way hash function according to a new PIN, the first encryption/decryption unit further encrypts the encryption/decryption key through the first encryption/decryption function according to the new PIN to generate a new cipher text, and the microprocessor unit stores the new PIN message digest and the new cipher text into the storage unit to replace the PIN message digest and the cipher text.

10. The controller according to claim 7, wherein the storage unit is a flash memory chip.

11. The controller according to claim 10, further comprising a flash memory interface module electrically connected to the microprocessor unit.

12. The controller according to claim 11, wherein the flash memory chip comprises a system area and a storage area, wherein the microprocessor unit stores the PIN message digest and the cipher text into the system area and stores the user data into the storage area.

13. The controller according to claim 12, wherein the storage area comprises a security area and a non-security area, and the encrypted user data is stored in the security area, wherein the microprocessor unit cannot detect the security area when the message digest does not match the PIN message digest.

14. A data protection method, suitable for protecting user data stored in a storage unit of a storage system, the data protection method comprising:
storing a PIN message digest and a cipher text in the storage unit;
generating a message digest through a one-way hash function according to a password received from a host system;
determining whether the message digest matches the PIN message digest, wherein when the message digest matches the PIN message digest, the cipher text is decrypted through a first encryption/decryption function according to the password to obtain an encryption/decryption key; and
encrypting and decrypting at least a part of the user data through a second encryption/decryption function according to the encryption/decryption key,
wherein the PIN message digest is initially generated through the one-way hash function according to a PIN, and the cipher text is initially generated by encrypting the encryption/decryption key through the first encryption/decryption function according to the PIN.

15. The data protection method according to claim 14, further comprising initially generating the encryption/decryption key in a random manner.

16. The data protection method according to claim 14, further comprising:
generating a new PIN message digest through the one-way hash function according to a new PIN;
encrypting the encryption/decryption key through the first encryption/decryption function according to the new PIN to generate a new cipher text; and
storing the new PIN message digest and the new cipher text into the storage unit to replace the PIN message digest and the cipher text.

17. The data protection method according to claim 14, wherein the storage unit is a flash memory chip.

18. The data protection method according to claim 17, further comprising:
dividing the flash memory chip into a system area and a storage area; and
storing the user data into the storage area,
wherein the step of storing the PIN message digest and the cipher text into the storage unit comprises storing the PIN message digest and the cipher text into the system area.

19. The data protection method according to claim 18, further comprising:
dividing the storage area into a security area and a non-security area; and
storing the encrypted user data into the security area,
wherein the security area is not shown when the message digest does not match the PIN message digest.

20. The data protection method according to claim 14, wherein the one-way hash function comprises MD5, RIPEMD-160 SHA1, SHA-256, SHA-386, or SHA-512.

21. The data protection method according to claim 14, wherein the first encryption/decryption function comprises an advanced encryption standard (AES) or a data encryption standard (DES).

22. The data protection method according to claim 14, wherein the second encryption/decryption function comprises an AES or a DES.
